(19) United States
(12) Patent Application Publication
(10) Pub. No.: US 2024/0194042 A1
(43) Pub. Date: Jun. 13, 2024

(54) PROCESSING APPARATUS, PROCESSING METHOD, AND NON-TRANSITORY STORAGE MEDIUM

(71) Applicant: NEC Corporation, Tokyo (JP)

(72) Inventor: Kazuya KAWAKAMI, Tokyo (JP)

(73) Assignee: NEC Corporation, Tokyo (JP)

(21) Appl. No.: 18/526,695

(22) Filed: Dec. 1, 2023

(30) Foreign Application Priority Data
Dec. 7, 2022 (JP) 2022-195564

(51) Int. Cl. G08B 13/196; G06T 7/246; G06T 7/73; G06V 20/52; G06V 40/10

(52) U.S. Cl. CPC G08B 13/196; G06T 7/246; G06T 7/73; G06V 20/52; G06V 40/10; G06T 2207/30201; G06T 2207/30232

(57) ABSTRACT

To detect that a surveillance-target person is in a prohibited facility, the present invention provides a processing apparatus 10 including: an acquisition unit 11 that acquires position information of a surveillance-target person; a decision unit 12 that decides whether the surveillance-target person is in a prohibited facility, based on registration information in which the prohibited facility is registered for each surveillance-target person, and based on the position information; and a processing unit 13 that executes predetermined processing when the surveillance-target person is decided to be in the prohibited facility.

This application is based upon and claims the benefit of priority from Japanese patent application No. 2022-195564, filed on Dec. 7, 2022, the disclosure of which is incorporated herein in its entirety by reference.

### TECHNICAL FIELD

The present invention relates to a processing apparatus, a processing system, a processing method, and a program.

### BACKGROUND ART

Patent Documents 1 to 5 disclose techniques related to the present invention.

The technique disclosed in Patent Document 1 (Japanese Patent Application Publication No. 2016-122300) uses a global positioning system (GPS) of a portable terminal, and thereby determines a user who is in a predetermined positional relation with a predetermined surveillance camera. Then, the technique uses image feature information of the determined user, and thereby determines the user in an image generated by the surveillance camera.

The technique disclosed in Patent Document 2 (Japanese Patent Application Publication No. 2011-145839) decides whether a person has intruded into a surveillance area, based on an image generated by a surveillance camera. Then, in a case of deciding that a person has intruded into the surveillance area, the technique performs notification processing, or determines the person by collation with identification information stored in advance.

The technique disclosed in Patent Document 3 (Japanese Patent Application Publication No. 2004-228649) detects an intruder in a detection area, with a sensor. Then, after detecting the intruder in the detection area, the technique captures an image of the intruder, with a camera.

The technique disclosed in Patent Document 4 (Japanese Patent Application Publication No. 2011-28357) captures an image of an entering person, with a surveillance camera. The surveillance camera captures an image at timing that an entering detection sensor detects entering of a passing person.

The technique disclosed in Patent Document 5 (International Patent Publication No. WO2020/213058) detects an intruder, based on an image generated by a surveillance camera.

### DISCLOSURE OF THE INVENTION

Some persons are prohibited from visiting a predetermined facility or purchasing a predetermined product. In this regard, a technique for detecting that a surveillance-target person is in the prohibited facility is desired. The prohibited facility is a facility that the surveillance-target person is prohibited from visiting, a store selling a product that the surveillance-target person is prohibited from purchasing, or the like.

The technique disclosed in Patent Document 1 can determine a user who is in a predetermined positional relation with a predetermined surveillance camera. Further, the techniques disclosed in Patent Documents 2 to 5 can detect an intruder who has intruded into a predetermined area. However, the techniques disclosed in Patent Documents 1 to 5 cannot detect that a surveillance-target person is in a prohibited facility. The prohibited facilities differ depending on surveillance-target persons. The techniques disclosed in Patent Documents 1 to 5 do not include means for determining a prohibited facility for each surveillance-target person.

In view of the above-described problem, one example of an object of the present invention is to provide a processing apparatus, a processing system, a processing method, and a program solving a problem of detecting that a surveillance-target person is in a prohibited facility.

According to one aspect of the present invention, there is provided a processing apparatus including:
an acquisition unit that acquires position information of a surveillance-target person;
a decision unit that decides whether the surveillance-target person is in a prohibited facility, based on registration information in which the prohibited facility is registered for each surveillance-target person, and based on the position information; and
a processing unit that executes predetermined processing when the surveillance-target person is decided to be in the prohibited facility.

Further, according to one aspect of the present invention, there is provided a processing system including:
a position information acquisition apparatus carried by a surveillance-target person; and
the above-described processing apparatus that acquires position information of the surveillance-target person from the position information acquisition apparatus.

Furthermore, according to one aspect of the present invention, there is provided a processing method including,
by at least one computer:
acquiring position information of a surveillance-target person;
deciding whether the surveillance-target person is in a prohibited facility, based on registration information in which the prohibited facility is registered for each surveillance-target person, and based on the position information; and
executing predetermined processing when the surveillance-target person is decided to be in the prohibited facility.

In addition, according to one aspect of the present invention, there is provided a program causing a computer to function as:
an acquisition unit that acquires position information of a surveillance-target person;
a decision unit that decides whether the surveillance-target person is in a prohibited facility, based on registration information in which the prohibited facility is registered for each surveillance-target person, and based on the position information; and
a processing unit that executes predetermined processing when the surveillance-target person is decided to be in the prohibited facility.

According to one aspect, a processing apparatus, a processing system, a processing method, and a program solving a problem of detecting that a surveillance-target person is in a prohibited facility are achieved.

### BRIEF DESCRIPTION OF THE DRAWINGS

The above-described object, other objects, and features and advantages will become more apparent from the following preferred example embodiments and the following drawings associated therewith.

FIG. 1 is a diagram illustrating one example of a functional block diagram of a processing apparatus.

FIG. 2 is a diagram illustrating one example of a functional block diagram of a processing system.

FIG. 3 is a diagram illustrating one example of a hardware configuration of the processing apparatus.

FIG. 4 is a diagram schematically illustrating one example of information processed by the processing apparatus.

FIG. 5 is a flowchart illustrating one example of a flow of processing of the processing apparatus.

FIG. 6 is a diagram schematically illustrating another example of information processed by the processing apparatus.

FIG. 7 is a diagram illustrating one example of a three-dimensional shape image.

FIG. 8 is a flowchart illustrating another example of a flow of processing of the processing apparatus.

FIG. 9 is a diagram schematically illustrating another example of information processed by the processing apparatus.

FIG. 10 is a flowchart illustrating another example of a flow of processing of the processing apparatus.

### DESCRIPTION OF EMBODIMENTS

Hereinafter, example embodiments of the present invention will be described with reference to the drawings. Note that, a similar constituent element is denoted by a similar reference sign in all the drawings, and description thereof will be appropriately omitted.

### First Example Embodiment

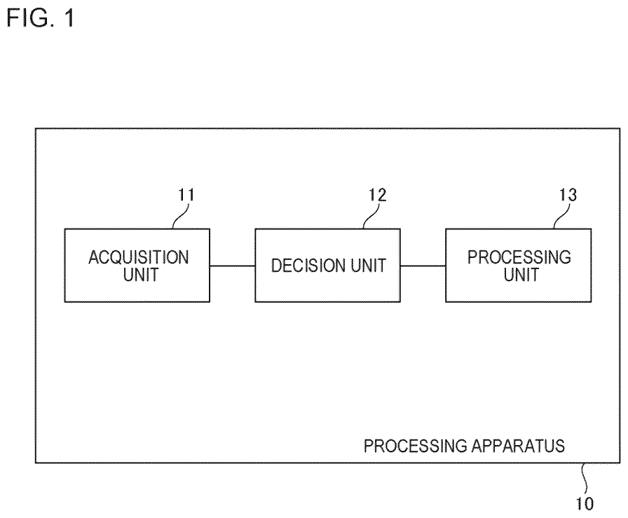

FIG. 1 is a functional block diagram illustrating an outline of a processing apparatus 10 according to a first example embodiment. The processing apparatus 10 includes an acquisition unit 11, a decision unit 12, and a processing unit 13.

The acquisition unit 11 acquires position information of a surveillance-target person. The decision unit 12 decides whether the surveillance-target person is in a prohibited facility, based on registration information in which the prohibited facility is registered for each surveillance-target person, and based on the position information acquired by the acquisition unit 11. When the surveillance-target person is decided to be in the prohibited facility, the processing unit 13 executes predetermined processing.

In such a manner, the processing apparatus 10 according to the present example embodiment decides whether a surveillance-target person is in a prohibited facility, based on registration information in which the prohibited facility is registered for each surveillance-target person, and based on position information of the surveillance-target person. According to such a processing apparatus 10, a problem of detecting that a surveillance-target person is in a prohibited facility is solved.

### Second Example Embodiment

### “Outline”

A processing apparatus 10 according to the present example embodiment decides whether a surveillance-target person is in a prohibited facility, based on registration information in which the prohibited facility is registered for each surveillance-target person, and based on position information of the surveillance-target person, similarly to the processing apparatus 10 according to the first example embodiment. In the present example embodiment, the processing is embodied. Hereinafter, details thereof will be described.

### “Configuration of Processing System 1”

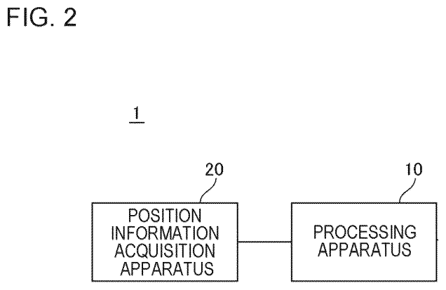

FIG. 2 illustrates a functional block diagram of a processing system 1 according to the present example embodiment. As illustrated in the drawing, the processing system 1 includes the processing apparatus 10 and a position information acquisition apparatus 20.

The position information acquisition apparatus 20 is an apparatus that acquires position information of each surveillance-target person and transmits the acquired position information to the processing apparatus 10. The processing apparatus 10 is an apparatus that decides whether each surveillance-target person is in a prohibited facility, based on the position information acquired from the position information acquisition apparatus 20. Hereinafter, configurations of these apparatuses will be described in detail.

### “Configuration of Position Information Acquisition Apparatus 20”

The position information acquisition apparatus 20 is an apparatus carried by each of a plurality of surveillance-target persons. The position information acquisition apparatus 20 may be a general-purpose apparatus such as a smartphone, a smart watch, or a mobile phone. Alternatively, the position information acquisition apparatus 20 may be a dedicated apparatus produced for surveillance of a surveillance-target person. The position information acquisition apparatus 20 may be a wearable terminal.

The position information acquisition apparatus 20 includes at least a position information acquisition function and a communication function.

The position information acquisition function is a function of acquiring position information that indicates a current position of the position information acquisition apparatus 20. The position information acquisition function may use a GPS, for example, for acquiring position information. Alternatively, the position information acquisition function may use another well-known technique for acquiring position information.

The communication function is a function of transmitting position information to the processing apparatus 10. The communication function may be a function of communicating by using a general communication line used by many users. Alternatively, the communication function may be a function of communicating by using a dedicated line.

The position information acquisition apparatus 20 uses the position information acquisition function and the communication function, and thereby transmits, to the processing apparatus 10, position information indicating a current position of an own apparatus. The position information acquisition apparatus 20 can transmit, at a predetermined time interval, to the processing apparatus 10, position information indicating a current position of the own apparatus. For example, the position information acquisition apparatus 20 transmits, to the processing apparatus 10, position information indicating a current position of the own apparatus, every few seconds or every few minutes.

### “Configuration of Processing Apparatus 10”

### —Hardware Configuration—

One example of a hardware configuration of the processing apparatus 10 will be described. Each function unit of the processing apparatus 10 is achieved by any combination of hardware and software. It is understood by those skilled in the art that there are various modifications for an achieving method thereof. Examples of the software include a program stored in advance at a stage of shipping an apparatus, and a program downloaded from a storage medium such as a compact disc (CD), a server on the Internet, or the like, and the like.

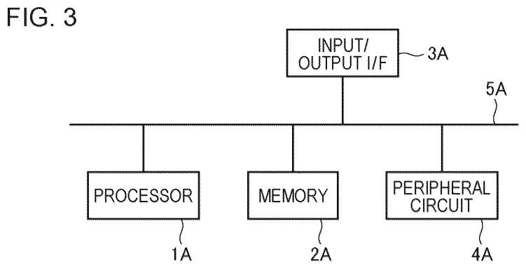

FIG. 3 is a block diagram illustrating the hardware configuration of the processing apparatus 10. As illustrated in FIG. 3, the processing apparatus 10 includes a processor 1A, a memory 2A, an input/output interface 3A, a peripheral circuit 4A, and a bus 5A. The peripheral circuit 4A includes various modules. The processing apparatus 10 does not need to include the peripheral circuit 4A. Note that, the processing apparatus 10 may be constituted of a plurality of physically and/or logically separated apparatuses. In this case, each of a plurality of the apparatuses can include the above-described hardware configuration.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a central processing unit (CPU) or a graphics processing unit (GPU). The memory 2A is, for example, a memory such as a random access memory (RAM) or a read only memory (ROM). The input/output interface 3A includes an interface for acquiring information from an input apparatus, an external apparatus, an external server, an external sensor, a camera, and/or the like, an interface for outputting information to an output apparatus, an external apparatus, an external server, and/or the like, and/or the like. In addition, the input/output interface 3A can include an interface for connecting to a communication network such as the Internet. The input apparatus includes, for example, a keyboard, a mouse, a microphone, a physical button, a touch panel, and/or the like. The output apparatus includes, for example, a display, a speaker, a printer, a mailer, and/or the like. The processor 1A can output a command to each module, and based on results of arithmetic operation thereof, the processor 1A can perform arithmetic operation.

### —Functional Configuration—

FIG. 1 is a functional block diagram illustrating an outline of the processing apparatus 10 according to a second example embodiment. The processing apparatus 10 includes an acquisition unit 11, a decision unit 12, and a processing unit 13.

The acquisition unit 11 acquires position information of a surveillance-target person.

The “surveillance-target person” refers to a person who is under surveillance made by a surveillance entity, concerning whether the person has visited a prohibited facility.

Examples of the “prohibited facility” include a facility that the surveillance-target person is prohibited from visiting, a store selling a product that the surveillance-target person is prohibited from purchasing, and the like. The prohibited facility may differ for each surveillance-target person. The prohibited facility of each surveillance-target person is set based on an attribute of each surveillance-target person. Examples of the attribute of the surveillance-target person include a criminal history; a medical history, and the like.

The “position information of a surveillance-target person” refers to information indicating a current position of the surveillance-target person. The acquisition unit 11 acquires position information of each surveillance-target person from the position information acquisition apparatus 20 carried by each of a plurality of the surveillance-target persons. The position information acquisition apparatus 20 transmits, to the processing apparatus 10, at a predetermined interval, position information indicating a current position of an own apparatus. Then, the acquisition unit 11 acquires, at the predetermined time interval, the position information indicating the current position of the position information acquisition apparatus 20.

“Acquisition” includes at least one of: “to take out, by an own apparatus, data or information stored in another apparatus or storage medium (active acquisition)”; and “to input, to the own apparatus, data or information output from another apparatus (passive acquisition)”. Examples of the active acquisition include: making a request or an inquiry to another apparatus and thereby receiving a reply thereto; accessing another apparatus or storage medium and thereby making reading-out; and the like. In addition, examples of the passive acquisition include receiving information delivered (or transmitted, or for which push notification is made, for example), and the like. Further, “acquisition” may be selecting and acquiring from received data or information, or selecting and receiving delivered data or information. This premise similarly applies to all the example embodiments.

Herein, examples of the surveillance-target person, the prohibited facility, and the surveillance entity are described. Note that, there is no limitation to the examples described herein.

For example, the surveillance-target person is an ex-convict who has committed a predetermined crime. The predetermined crime is an assault incident, a violence incident, an incident involving a gun, or the like. The prohibited facility in this case is, for example, a store that sells a gun. Then, the surveillance entity is the police, an administrative agency, or the like.

In another example, the surveillance-target person is a person who is receiving treatment for alcoholism. the prohibited facility in this case is, for example, a store that sells alcohol, a bar that serves alcohol, and the like. The, the surveillance entity is a medical institution, an administrative agency, or the like that is involved in the treatment.

In another example, the surveillance-target person is an infected person who is infected with a predetermined infectious disease. the prohibited facility in this case is, for example, a facility, such as an amusement park, where many persons gather and that is inappropriate to visit during infection. Then, the surveillance entity is a medical institution, an administrative agency, or the like that is involved in the treatment.

In another example, the surveillance-target person is a stalker criminal. The prohibited facility in this case is a home, a workplace, and/or the like of a person who is stalked. Then, the surveillance entity is the police, an administrative agency, or the like.

The decision unit 12 decides whether the surveillance-target person is in the prohibited facility, based on the registration information in which the prohibited facility is registered for each surveillance-target person, and based on position information acquired by the acquisition unit 11.

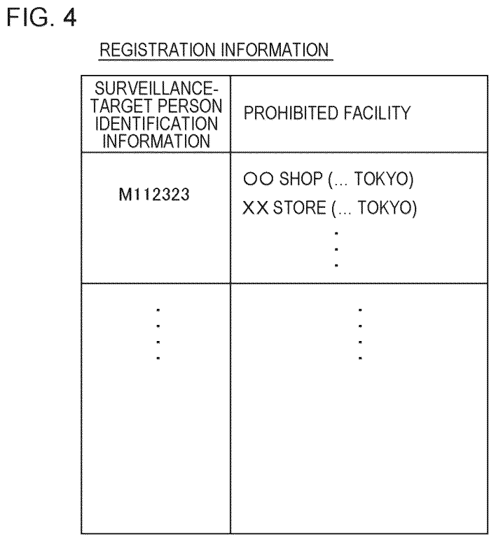

FIG. 4 illustrates one example of the registration information. The illustrated registration information is information in which surveillance-target person identification information and a prohibited facility are associated with each other.

The “surveillance-target person identification information” refers to information that identifies a plurality of surveillance-target persons to each other.

The information illustrated in a column of “prohibited facility” is information indicating the prohibited facility for each surveillance-target person. For example, the information indicates a name, an address, and/or the like of the prohibited facility.

The decision unit 12 determines the prohibited facility for each surveillance-target person, based on the registration information as illustrated in FIG. 4. Then, the decision unit 12 compares position information (an address and/or the like) of the determined prohibited facility with position information of the surveillance-target person acquired by the acquisition unit 11, and thereby decides whether the surveillance-target person is in the prohibited facility.

There are various “references for deciding that the surveillance-target person is in the prohibited facility”. For example, the decision unit 12 may decide that the surveillance-target person is in the prohibited facility in a case of “a position indicated by position information of the surveillance-target person exists in an area of the prohibited facility”. Alternatively, the decision unit 12 may decide that the surveillance-target person is in the prohibited facility in a case of “a position indicated by position information of the surveillance-target person exists in an area of the prohibited facility or within a predetermined distance from the area”. This is a reference that takes into account an error in the position information acquired by the position information acquisition apparatus 20. Note that, the references exemplified herein are merely examples, and there are no limitation thereto.

Incidentally; when a plurality of surveillance-target persons are under surveillance made by the processing apparatus 10, a means for determining which surveillance-target person the position information acquired by the acquisition unit 11 is related to is necessary. Hereinafter, one example of the means will be described, but there is no limitation to this example.

For example, the surveillance-target person identification information and terminal identification information of the position information acquisition apparatus 20 carried by each surveillance-target person may be associated with each other in advance and registered in the processing apparatus 10. Then, the decision unit 12 may determine the surveillance-target person identification information associated with the terminal identification information of the position information acquisition apparatus 20 that has transmitted the position information acquired by the acquisition unit 11. Alternatively, surveillance-target person identification information of the surveillance-target person who carries each position information acquisition apparatus 20 may be registered in advance in each position information acquisition apparatus 20. Then, the position information acquisition apparatus 20 may transmit, to the processing apparatus 10, the registered surveillance-target person identification information and the position information in association with each other.

Returning to FIG. 1, the processing unit 13 executes predetermined processing when the decision unit 12 decides that the surveillance-target person is in the prohibited facility. Note that, the processing unit 13 does not execute the predetermined processing when the decision unit 12 does not decide that the surveillance-target person is in the prohibited facility.

One example of the predetermined processing is warning processing. In one example of the warning processing, the processing unit 13 transmits warning information to the position information acquisition apparatus 20 of the surveillance-target person decided to be in the prohibited facility. In this case, the position information acquisition apparatus 20 outputs the warning information in response to receiving the warning information. Specifically, the position information acquisition apparatus 20 may output a predetermined warning message via a display or a speaker. For example, the warning message is “Your presence in the prohibited facility has been detected. Please leave promptly.”, or the like. In addition or alternatively, the position information acquisition apparatus 20 may output a warning sound via a speaker. In addition or alternatively, the position information acquisition apparatus 20 may turn on a warning lamp.

In another example of the warning processing, the processing unit 13 transmits the warning information to a pre-registered terminal of the surveillance entity. The warning information in this case may include information (such as a name) identifying the surveillance-target person decided to be in the prohibited facility. In addition, the warning information may include information (such as a name and an address) identifying the prohibited facility where the surveillance-target person is present. The terminal of the surveillance entity outputs the received warning information. Specifically, the terminal of the surveillance entity may output a predetermined warning message via a display or a speaker. For example, the warning message is “presence of the surveillance-target person in the prohibited facility has been detected”, or the like. In addition, the warning message may include information (such as a name) identifying the surveillance-target person decided to be in the prohibited facility, and information (such as a name and an address) identifying the prohibited facility where the surveillance-target person is present. In addition or alternatively, the terminal of the surveillance entity may output a warning sound via a speaker. In addition or alternatively; the terminal of the surveillance entity may turn on a warning lamp.

Note that, the predetermined processing executed by the processing unit 13 may be processing other than the above-described warning processing.

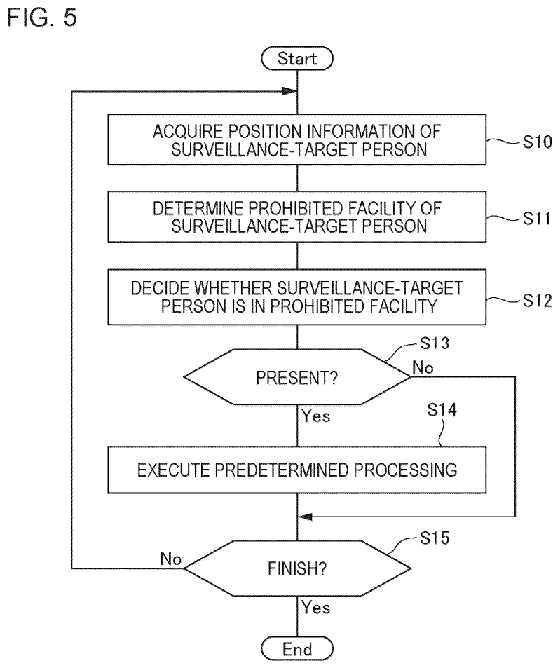

Next, one example of a flow of processing of the processing apparatus 10 will be described with reference to a flowchart in FIG. 5.

First, the processing apparatus 10 acquires position information of a surveillance-target person (S10). Next, the processing apparatus 10 determines a prohibited facility of the surveillance-target person, based on registration information in which the prohibited facility is registered for each surveillance-target person (S11). Next, the processing apparatus 10 decides whether the surveillance-target person is in the prohibited facility determined in S11, based on the position information acquired in S10 (S12).

When the surveillance-target person is decided to be in the prohibited facility determined in S11 (Yes in S13), the processing apparatus 10 executes predetermined processing (S14). On the other hand, when the surveillance-target person is decided to be not in the prohibited facility determined in S11 (No in S13), the processing apparatus 10 does not execute the predetermined processing.

After that, the processing apparatus 10 repeats the similar processing.

### “Advantageous Effect”

According to the processing apparatus 10, the position information acquisition apparatus 20, and the processing system 1 of the present example embodiment, it can be decided whether a surveillance-target person is in a prohibited facility, based on registration information in which the prohibited facility is registered for each surveillance-target person, and based on position information of the surveillance-target person. According to the processing apparatus 10, the position information acquisition apparatus 20, and the processing system 1 described above, a problem of detecting that a surveillance-target person is in a prohibited facility is solved.

### Third Example Embodiment

As described in the first and second example embodiments, the processing apparatus 10 decides whether a surveillance-target person is in a prohibited facility, based on position information acquired from the position information acquisition apparatus 20. However, in a case of this means, whether a surveillance-target person is in a prohibited facility cannot be accurately decided in some cases, because of an issue of accuracy in position information acquired by the position information acquisition apparatus 20. For example, there is a possibility that simple presence of a surveillance-target person in front of a prohibited facility results in erroneous decision that the surveillance-target person is in the prohibited facility.

A processing apparatus 10 according to the present example embodiment uses personal authentication processing, and thereby further performs processing of deciding whether a surveillance-target person is in a prohibited facility, as predetermined processing performed when the surveillance-target person is decided to be in the prohibited facility. Hereinafter, details thereof are described.

A processing unit 13 executes the predetermined processing when a decision unit 12 decides that a surveillance-target person is in a prohibited facility.

The processing unit 13 performs the following processing as the predetermined processing. First, the processing unit 13 acquires a camera image capturing an inside or surroundings of the prohibited facility where the surveillance-target person is decided to be present. Next, the processing unit 13 decides whether the surveillance-target person is in the prohibited facility, by personal authentication processing based on the acquired camera image.

When it is decided by the personal authentication processing that the surveillance-target person is in the prohibited facility, the processing unit 13 may perform warning processing described in the second example embodiment. In this example, “decision that the surveillance-target person is in the prohibited facility, made by the personal authentication processing of the processing unit 13” triggers execution of the warning processing. Only “decision that the surveillance-target person is in the prohibited facility, made by processing of the decision unit 12, based on position information of the surveillance-target person” does not cause execution of the warning processing.

Hereinafter, “processing of acquiring a camera image capturing an inside or surroundings of a prohibited facility” and “processing of deciding whether a surveillance-target person is in the prohibited facility, by the personal authentication processing based on the acquired camera image” are described in detail.

### “Processing of Acquiring Camera Image Capturing Inside or Surroundings of Prohibited Facility”

A surveillance camera that captures an image of at least one of an inside and surroundings of the prohibited facility is installed in advance. Then, when the decision unit 12 decides that the surveillance-target person is in the prohibited facility, the processing unit 13 acquires, for the personal authentication processing, a camera image generated by the surveillance camera installed in the prohibited facility. The surveillance camera or an apparatus that accumulates camera images generated by the surveillance camera, and the processing apparatus 10 are configured in advance in such a way as to be able to communicate with each other.

### “Processing of Deciding Whether Surveillance-Target Person is in Prohibited Facility, by Personal Authentication Processing Based on Acquired Camera Image”

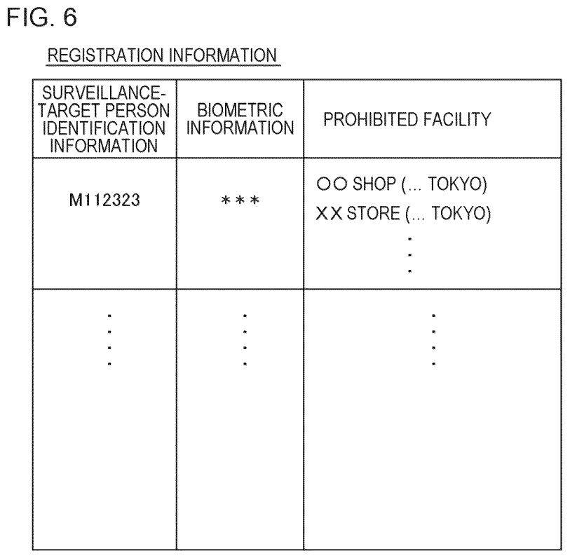

In the present example embodiment, as illustrated in FIG. 6, biometric information of each surveillance-target person is registered as registration information of the surveillance-target person. The processing unit 13 performs personal authentication by using the biometric information. In other words, the processing unit 13 decides whether a person captured in the acquired camera image is the surveillance-target person.

When the surveillance-target person is detected, by the personal authentication processing, from among persons captured in a camera image of “inside” of the prohibited facility, the processing unit 13 decides that the surveillance-target person is in the prohibited facility. On the other hand, when the surveillance-target person is not detected, by the personal authentication processing, from among persons captured in a camera image of “inside” of the prohibited facility; the processing unit 13 decides that the surveillance-target person is not in the prohibited facility.

In addition, when the surveillance-target person is detected, by the personal authentication processing, from among persons captured in a camera image of “surroundings” of the prohibited facility; the processing unit 13 decides that the surveillance-target person is not in the prohibited facility. The “surroundings” of the prohibited facility refers to “outside” of the prohibited facility.

The personal authentication processing uses, as biometric information, at least one of a camera image of a person, an image being restored from a camera image and representing a three-dimensional shape of a person, a feature value of a gait of a person, a feature value of a physique of a person, a feature value of a face of a person, and a feature value of an iris of a person. In other words, these pieces of information is registered as biometric information of each surveillance-target person in the processing apparatus 10.

The “camera image” refers to an image generated by a camera. The camera image may be a still image, or may be a moving image. The camera may be a camera including a sensor that detects visible light. Alternatively, the camera may be a camera including a sensor that detects invisible light (such as infrared light).

The “camera image of a person” represents a face of a person, or a part or entirety of a body of a person. Use of such a camera image of a person enables personal authentication processing using well-known face authentication technique or the like to be performed.

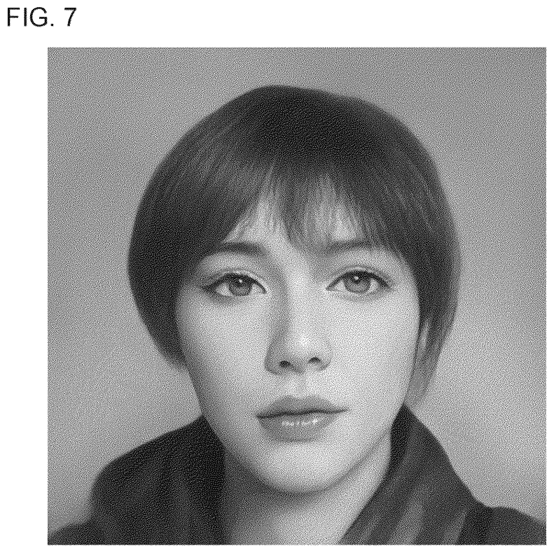

The “image being restored from a camera image and representing a three-dimensional shape of a person” refers to an image representing the three-dimensional shape of the person captured in the camera image. Hereinafter, such an image is referred to as “three-dimensional shape image”. FIG. 7 illustrates one example of a three-dimensional shape image. As illustrated in FIG. 7, the three-dimensional shape image can represent a three-dimensional shape of a face of a person. Alternatively, although not illustrated in the drawing, the three-dimensional shape image may represent a three-dimensional shape of a body (an upper half of a body, a lower half of a body, and/or the like) of a person. The three-dimensional shape image is an “image designed by a computer” being restored from a camera image. A means for restoring a three-dimensional shape image from a camera image is not particularly limited, and any techniques can be adopted as the means.

As illustrated in FIG. 7, a three-dimensional shape image represents a feature of an appearance of a person, similarly to a camera image. Thus, various feature values (a position, a shape, and a size of each part, a relative positional relation between or among a plurality of parts, an extracted keypoint, and/or the like) of an appearance of a person can be extracted from a three-dimensional shape image, similarly to a case of a camera image. Thus, personal authentication processing using a well-known face authentication technique or the like can be performed similarly to a case of using a camera image.

The “feature value of a gait of a person” concerns at least one of a motion manner of four limbs in a fixed distance, trajectories of a joint and a head, a stride length, and velocity.

The “motion manner of four limbs in a fixed distance” refers to a feature of a manner in which a person moves the four limbs while moving the fixed distance. The feature of the motion manner of the four limbs may be represented by movement trajectories of feature points of the four limbs, for example. The feature points of the four limbs may be joint portions of the four limbs, distal ends of the four limbs, or other parts of the four limbs. The movement trajectories of the feature points of the four limbs may be represented in a three-dimensional space. Alternatively, the movement trajectories of the feature points of the four limbs may represent trajectories of changes (up-down changes) in heights (heights from the ground) of the feature points. Alternatively, the movement trajectories of the feature points of the four limbs may be time changes in relative positions with respect to a reference point in a body. The reference point is a head portion, a waist portion, or the like, but is not limited thereto.

The “trajectories of a joint and a head” may be represented in a three-dimensional space. Alternatively, the trajectories of the joint and the head may represent trajectories of changes (up-down changes) in heights (heights from the ground) of the joint and the head. Alternatively, the trajectories of the joint and the head may be time changes in relative positions with respect to a reference point in a body. The reference point is a head portion, a waist portion, or the like, but is not limited thereto.

The feature value of the gait of a person as described above can be computed based on a moving image generated by a camera. For example, using a technique such as OpenPose enables extraction of a joint point of a person in an image. Movement trajectories of the joint points in the moving image are acquired, and thereby, a feature value of the gait of the person as described above is computed.

The “stride length”, “velocity”, “a feature value of a physique of a person”, “a feature value of a face of a person”, and “a feature value of an iris of a person” are widely known, and thus, description thereof is omitted herein.

Incidentally, because of a privacy issue, there is a case in which a camera image of a surveillance-target person cannot be registered as registration information in a database. In this case, the processing unit 13 registers, in the database, as the registration information, biometric information as described above other than a camera image, and performs the personal authentication processing. Even when a camera image of a person cannot be registered in the database because of a privacy issue, there is a case in which other biometric information can be registered.

Next, one example of a flow of processing of the processing apparatus 10 according to the present example embodiment will be described. The one example of the flow of the processing of the processing apparatus 10 according to the present example embodiment is illustrated in the flowchart in FIG. 5. The flow of the processing in FIG. 5 is described in the second example embodiment.

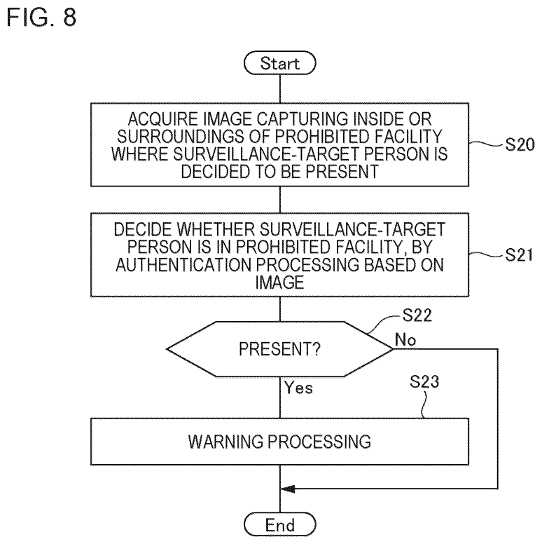

Then, in the present example embodiment, the processing of S14 in the flowchart in FIG. 5 is illustrated in a flowchart in FIG. 8. Hereinafter, the one example of the flow of the processing of the processing apparatus 10 is described with reference to the flowchart in FIG. 8.

First, the processing apparatus 10 acquires a camera image capturing an inside or surroundings of a prohibited facility where a surveillance-target person is decided to be present (S20).

Next, the processing apparatus 10 decides whether the surveillance-target person is in the prohibited facility; by personal authentication processing based on the acquired camera image (S21).

For example, when the surveillance-target person is detected, by the personal authentication processing, from among persons captured in the camera image of “inside” of the prohibited facility, the processing apparatus 10 decides that the surveillance-target person is in the prohibited facility. On the other hand, when the surveillance-target person is not detected, by the personal authentication processing, from among persons captured in the camera image of “inside” of the prohibited facility, the processing apparatus 10 decides that the surveillance-target person is not in the prohibited facility. Alternatively, when the surveillance-target person is detected, by the personal authentication processing, from among persons captured in the camera image of “surroundings” of the prohibited facility, the processing apparatus 10 may decide that the surveillance-target person is not in the prohibited facility.

When the surveillance-target person is decided to be in the prohibited facility (Yes in S22), the processing apparatus 10 performs warning processing (S23). On the other hand, when the surveillance-target person is decided to be not in the prohibited facility (No in S22), the processing apparatus 10 does not perform the warning processing. Details of the warning processing are described in the second example embodiment.

After that, the processing apparatus 10 repeats the similar processing.

The other configurations of the processing apparatus 10, a position information acquisition apparatus 20, and a processing system 1 according to the present example embodiment are similar to those in the first and second example embodiments.

According to the processing apparatus 10, the position information acquisition apparatus 20, and the processing system 1 of the present example embodiment, an advantageous effect similar to that in the first and second example embodiments is achieved.

Further, according to the processing apparatus 10, the position information acquisition apparatus 20, and the processing system 1 of the present example embodiment, when it is decided based on position information of the position information acquisition apparatus 20 that a surveillance-target person is in a prohibited facility, it can be decided whether the surveillance-target person is in the prohibited facility, by using the personal authentication processing.

Whether a surveillance-target person is in a prohibited facility cannot be accurately decided in some cases, because of an issue of accuracy in position information of the position information acquisition apparatus 20. For example, there is a possibility that simple presence of a surveillance-target person in front of a prohibited facility results in erroneous decision that the surveillance-target person is in the prohibited facility. According to the processing apparatus 10 of the present example embodiment having the configuration as described above, whether a surveillance-target person is in a prohibited facility can be accurately decided.

In addition, by performing the personal authentication processing on camera images of all prohibited facilities and all surveillance-target persons, it can be more accurately detected that the surveillance-target person is in the prohibited facility. However, such a configuration increases a processing load of a computer. As in the present example embodiment, the personal authentication processing is performed only on a camera image of a prohibited facility where a surveillance-target person is decided, by the decision unit 12, to be present, and on the surveillance-target person, and thereby, a processing load on the computer can be reduced.

### Fourth Example Embodiment

A processing apparatus 10 according to the present example embodiment performs processing of determining an action content that is being taken by a surveillance-target person in a prohibited facility, as predetermined processing performed when the surveillance-target person is decided to be in the prohibited facility. Hereinafter, details thereof will be described.

When a decision unit 12 decides that a surveillance-target person is in a prohibited facility; a processing unit 13 executes the predetermined processing. The processing unit 13 executes, as the predetermined processing, processing of determining an action content of the surveillance-target person decided to be in the prohibited facility.

In a modified example, when the decision unit 12 decides that a surveillance-target person is in a prohibited facility; the processing unit 13 may perform the personal authentication processing described in the third example embodiment. Then, when the surveillance-target person is decided to be in the prohibited facility by the personal authentication processing, the processing unit 13 may execute the processing of determining an action content of the surveillance-target person.

The processing unit 13 may perform warning processing described in the second example embodiment, depending on a result of the processing of determining an action content of the surveillance-target person. Specifically, when the processing unit 13 decides that the surveillance-target person is taking a predetermined prohibited action, the processing unit 13 may perform the warning processing described in the second example embodiment. In this example, “decision that the surveillance-target person is taking the predetermined prohibited action” triggers execution of the warning processing. Only “decision that the surveillance-target person is in the prohibited facility” does not cause execution of the warning processing.

The “prohibited action” is set in advance for each surveillance-target person. A content of the prohibited action is registered in the processing apparatus 10, in association with each surveillance-target person. Examples of the prohibited action include “picking up a product (e.g., a gun, alcohol, or the like) of which purchase is prohibited”, “bringing, to a checkout counter, a product of which purchase is prohibited”, “drinking of alcohol”, and the like.

Herein, the processing of determining an action content of a surveillance-target person will be described.

The processing unit 13 determines an action content, based on a camera image being captured in a prohibited facility and concerning a surveillance-target person. A plurality of prohibited actions are defined in advance. Then, the processing unit 13 decides whether the surveillance-target person is taking any of these prohibited actions.

There are various means for deciding whether the prohibited action defined in advance is being taken. One example thereof is use of machine learning. Specifically, a camera image of a person taking each prohibited action is prepared as learning data. Then, machine learning based on the learning data generates an estimation model of deciding whether a person captured in a camera image is taking each prohibited action. The processing unit 13 inputs, to the estimation model, a camera image captured in a prohibited facility and concerning a surveillance-target person, and acquires an output thereof. The output indicates a degree of certainty that the surveillance-target person captured in the input camera image is taking each of a plurality of the prohibited actions defined in advance. Then, the processing unit 13 decides that the surveillance-target person captured in the camera image is taking the prohibited action for which the degree of certainty is equal to or higher than a reference value.

The other configurations of the processing apparatus 10, a position information acquisition apparatus 20, and a processing system 1 according to the present example embodiment are similar to those in the first to third example embodiments.

According to the processing apparatus 10, the position information acquisition apparatus 20, and the processing system 1 of the present example embodiment, an advantageous effect similar to that in the first to third example embodiments is achieved.

Further, according to the processing apparatus 10, the position information acquisition apparatus 20, and the processing system 1 of the present example embodiment, when a surveillance-target person is decided to be in a prohibited facility, an action content of the surveillance-target person can be determined. Specifically, it can be decided whether the surveillance-target person is taking a predetermined prohibited action. As a result, the action content of the surveillance-target person can be recognized.

### Fifth Example Embodiment

In the present example embodiment, a movement-permitted area is set for each surveillance-target person. Then, a processing apparatus 10 according to the present example embodiment detects “the surveillance-target person has moved out of the movement-permitted area” and “being within a prohibited facility within the movement-permitted area”.

Note that, when the surveillance-target person is outside the movement-permitted area, “the surveillance-target person has moved out of the movement-permitted area” is detected. Thus, in the present example embodiment, “being in a prohibited facility outside the movement-permitted area” is not a detection target. Such a configuration can reduce a processing load of the processing apparatus 10. Hereinafter, details thereof will be described.

A decision unit 12 decides whether a surveillance-target person is within a movement-permitted area, based on position information acquired by an acquisition unit 11.

The “movement-permitted area” refers to an area within which each surveillance-target person can move. In other words, each surveillance-target person is not permitted to move out of the movement-permitted area.

There are various manners of defining the movement-permitted area. For example, an area within a predetermined distance from a home of each surveillance-target person may be defined as the movement-permitted area. Alternatively, the movement-permitted area may be defined by a place name such as “Japan”, “Tokyo”, or “Shinagawa ward”.

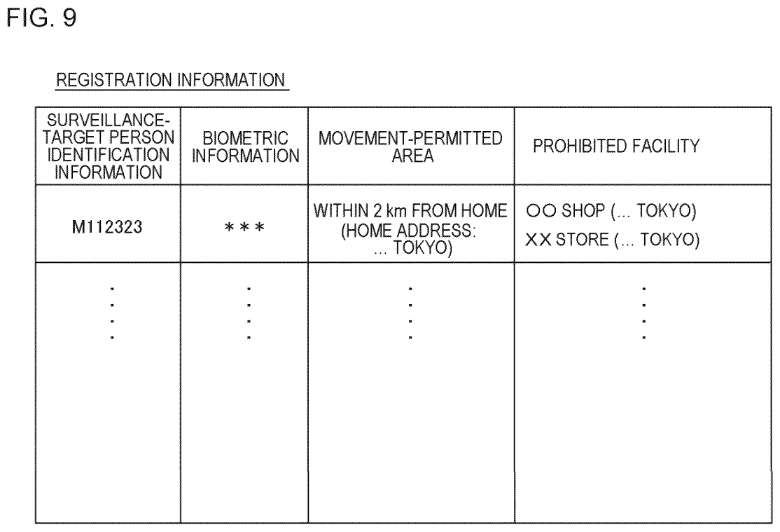

In the present example embodiment, as illustrated in FIG. 9, the movement-permitted area of each surveillance-target person is registered as registration information of the surveillance-target person. By using the information, the decision unit 12 determines the movement-permitted area of each surveillance-target person.

When a position indicated by position information acquired by the acquisition unit 11 is within the movement-permitted area, the decision unit 12 decides that the surveillance-target person is within the movement-permitted area. Then, when a position indicated by position information acquired by the acquisition unit 11 is outside the movement-permitted area, the decision unit 12 decides that the surveillance-target person is not within the movement-permitted area.

Incidentally, in the registration information of the present example embodiment, a prohibited facility existing within the movement-permitted area of each surveillance-target person is registered as a prohibited facility of each surveillance-target person. In other words, a prohibited facility existing outside the movement-permitted area is not registered.

Then, based on such registration information, the decision unit 12 decides whether each surveillance-target person is in the prohibited facility existing within the movement-permitted area of each surveillance-target person. The decision unit 12 does not decide whether each surveillance-target person is in a prohibited facility outside the movement-permitted area of each surveillance-target person.

When the surveillance-target person is decided to be not within the movement-permitted area, the processing unit 13 can execute predetermined processing. For example, the predetermined processing is warning processing described in the second example embodiment. Similar processing can be performed while a content of a message to be output is appropriately changed.

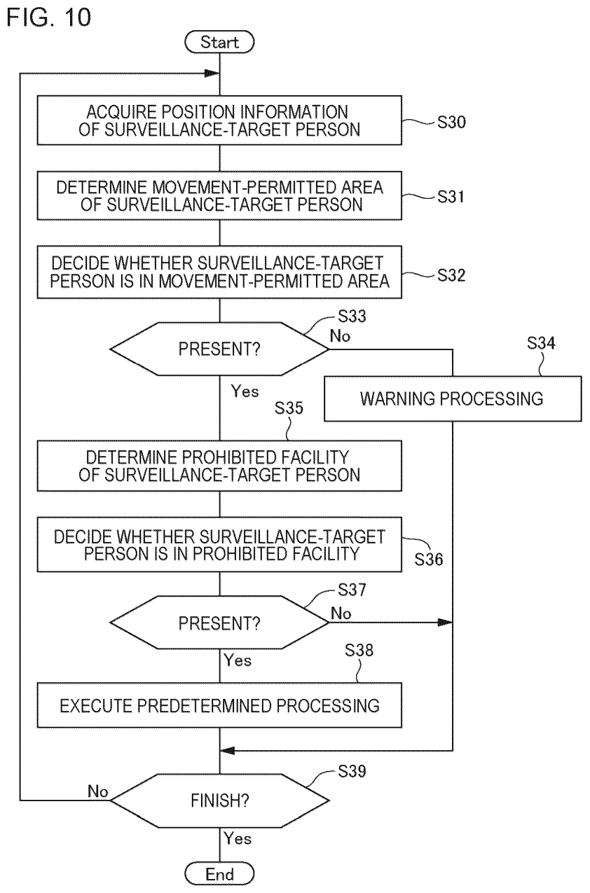

Next, one example of a flow of processing of the processing apparatus 10 will be described with reference to a flowchart in FIG. 10.

First, the processing apparatus 10 acquires position information of a surveillance-target person (S30). Next, the processing apparatus 10 determines a movement-permitted area of the surveillance-target person, based on registration information in which the movement-permitted area is registered for each surveillance-target person (S31). Next, the processing apparatus 10 decides whether the surveillance-target person is within the movement-permitted area determined in S31, based on the position information acquired in S30 (S32).

When the surveillance-target person is decided to be not within the movement-permitted area determined in S31 (No in S33), the processing apparatus 10 performs the warning processing (S34).

On the other hand, when the surveillance-target person is decided to be within the movement-permitted area determined in S31 (Yes in S33), the processing apparatus 10 determines a prohibited facility of the surveillance-target person, based on the registration information in which the prohibited facility is registered for each surveillance-target person (S35). Next, the processing apparatus 10 decides whether the surveillance-target person is in the prohibited facility determined in S35, based on the position information acquired in S30 (S36).

When the surveillance-target person is decided to be in the prohibited facility determined in S35 (Yes in S37), the processing apparatus 10 executes predetermined processing (S38). Details of the predetermined processing are described in the second to fourth example embodiments. On the other hand, when the surveillance-target person is decided to be not in the prohibited facility determined in S35 (No in S37), the processing apparatus 10 does not execute the predetermined processing.

After that, the processing apparatus 10 repeats the similar processing.

The other configurations of the processing apparatus 10, a position information acquisition apparatus 20, and a processing system 1 according to the present example embodiment are similar to those in the first to fourth example embodiments.

According to the processing apparatus 10, the position information acquisition apparatus 20, and the processing system 1 of the present example embodiment, an advantageous effect similar to that in the first to fourth example embodiments is achieved.

Further, according to the processing apparatus 10, the position information acquisition apparatus 20, and the processing system 1 of the present example embodiment, “a surveillance-target person has moved out of a movement-permitted area” and “being in a prohibited facility within the movement-permitted area” can be detected. Thus, a range of a content that can be detected is widened.

Furthermore, in the present example embodiment, when a surveillance-target person is outside a movement-permitted area, “the surveillance-target person has moved out of the movement-permitted area” is detected. Thus, in the present example embodiment, “being in a prohibited facility outside the movement-permitted area” is not a detection target. Such a configuration can reduce a processing load of the processing apparatus 10.

### Modified Example

In the fifth example embodiment, “a surveillance-target person is in a prohibited facility outside a movement-permitted area” is not a detection target.

In the modified example, “a surveillance-target person is in a prohibited facility outside a movement-permitted area” is also a detection target. In other words, not only a “prohibited facility within the movement-permitted area” but also a “prohibited facility outside the movement-permitted area” are registered in registration information of the surveillance-target person (refer to FIG. 9).

For example, “all prohibited facilities outside the movement-permitted area” may be registered in the registration information. However, such a configuration increases a processing load of a computer. In this regard, instead of “all prohibited facilities outside the movement-permitted area”, “prohibited facilities that are among prohibited facilities outside the movement-permitted area and that are within a predetermined distance from the movement-permitted area” may be registered in the registration information.

Although the example embodiments of the present invention are described above with reference to the drawings, these are exemplifications of the present invention, and various configurations other than those described above can also be adopted. The configurations of the above-described example embodiments may be combined with each other, or a part of the configurations may be replaced with another or others of the configurations. In addition, the configurations of the above-described example embodiments may be variously modified within a range that does not depart from the essence of the present invention. Further, the configurations and pieces of the processing disclosed in the above-described example embodiments and modified examples may be combined with each other.

In addition, in a plurality of the flowcharts used in the above description, a plurality of the steps (pieces of processing) are described in order. However the execution order of the steps executed in each example embodiment is not limited to the described order. In each example embodiment, the order of the illustrated steps can be changed within a range in which inconvenience does not occur in the content. The above-described each example embodiment can be combined within a range in which contradiction does not occur in the content.

A part or all of the above-described example embodiments can also be described as in the following supplementary notes, but there is no limitation to the following.

1. A processing apparatus including:
an acquisition unit that acquires position information of a surveillance-target person;
a decision unit that decides whether the surveillance-target person is in a prohibited facility, based on registration information in which the prohibited facility is registered for each surveillance-target person, and based on the position information; and
a processing unit that executes predetermined processing when the surveillance-target person is decided to be in the prohibited facility.
   2. The processing apparatus according to supplementary note 1, wherein
the registration information further registers a movement-permitted area for the each surveillance-target person, and
the decision unit further decides whether the surveillance-target person is within the movement-permitted area.
   3. The processing apparatus according to supplementary note 2, wherein
the registration information registers the movement-permitted area and the prohibited facility existing within the movement-permitted area, for the each surveillance-target person, and
the decision unit
   decides whether the surveillance-target person is within the movement-permitted area, and
   further decides whether the surveillance-target person is in the prohibited facility existing within the movement-permitted area.
      4. The processing apparatus according to any one of supplementary notes 1 to 3, wherein
the prohibited facility is a facility being set based on an attribute of the surveillance-target person.
   5. The processing apparatus according to any one of supplementary notes 1 to 4, wherein
the processing unit executes, as the predetermined processing, processing of acquiring an image capturing an inside or surroundings of the prohibited facility, and deciding whether the surveillance-target person is in the prohibited facility, by personal authentication processing based on the image.
   6. The processing apparatus according to supplementary note 5, wherein
the personal authentication processing uses at least one of a camera image of a person, an image being restored from a camera image and representing a three-dimensional shape of a person, a feature value of a gait of a person, a feature value of a physique of a person, a feature value of a face of a person, and a feature value of an iris of a person.
   7. The processing apparatus according to any one of supplementary notes 1 to 6, wherein
the processing unit executes, as the predetermined processing, processing of determining an action content of the surveillance-target person who is decided to be in the prohibited facility.
   8. A processing system including:
a position information acquisition apparatus carried by a surveillance-target person; and
the processing apparatus according to any one of supplementary notes 1 to 7 that acquires position information of the surveillance-target person from the position information acquisition apparatus.
   9. A processing method including,
by at least one computer:
acquiring position information of a surveillance-target person;
deciding whether the surveillance-target person is in a prohibited facility, based on registration information in which the prohibited facility is registered for each surveillance-target person, and based on the position information; and
executing predetermined processing when the surveillance-target person is decided to be in the prohibited facility.
   10. A program causing a computer to function as:
an acquisition unit that acquires position information of a surveillance-target person;
a decision unit that decides whether the surveillance-target person is in a prohibited facility, based on registration information in which the prohibited facility is registered for each surveillance-target person, and based on the position information; and
a processing unit that executes predetermined processing when the surveillance-target person is decided to be in the prohibited facility.
1 Processing system
10 Processing apparatus
11 Acquisition unit
12 Decision unit
13 Processing unit
20 Position information acquisition apparatus
1A Processor
2A Memory
3A Input/output I/F
4A Peripheral circuit
5A Bus

1. A processing apparatus comprising:
at least one memory configured to store one or more instructions; and
at least one processor configured to execute the one or more instructions to:
acquire position information of a surveillance-target person;
decide whether the surveillance-target person is in a prohibited facility, based on registration information in which the prohibited facility is registered for each surveillance-target person, and based on the position information; and
execute predetermined processing when the surveillance-target person is decided to be in the prohibited facility.

2. The processing apparatus according to claim 1, wherein
the registration information further registers a movement-permitted area for the each surveillance-target person, and
the processor is further configured to execute the one or more instructions to decide whether the surveillance-target person is within the movement-permitted area.

3. The processing apparatus according to claim 2, wherein
the registration information registers the movement-permitted area and the prohibited facility existing within the movement-permitted area, for the each surveillance-target person, and
the processor is further configured to execute the one or more instructions to
decide whether the surveillance-target person is within the movement-permitted area, and
decide whether the surveillance-target person is in the prohibited facility existing within the movement-permitted area.

4. The processing apparatus according to claim 1, wherein
the prohibited facility is a facility being set based on an attribute of the surveillance-target person.

5. The processing apparatus according to claim 1, wherein
the processor is further configured to execute the one or more instructions to execute, as the predetermined processing, processing of acquiring an image capturing an inside or surroundings of the prohibited facility, and deciding whether the surveillance-target person is in the prohibited facility, by personal authentication processing based on the image.

6. The processing apparatus according to claim 5, wherein
the personal authentication processing uses at least one of a camera image of a person, an image being restored from a camera image and representing a three-dimensional shape of a person, a feature value of a gait of a person, a feature value of a physique of a person, a feature value of a face of a person, and a feature value of an iris of a person.

7. The processing apparatus according to claim 1, wherein
the processor is further configured to execute the one or more instructions to execute, as the predetermined processing, processing of determining an action content of the surveillance-target person who is decided to be in the prohibited facility.

8. A processing method comprising,
by at least one computer:
acquiring position information of a surveillance-target person;
deciding whether the surveillance-target person is in a prohibited facility, based on registration information in which the prohibited facility is registered for each surveillance-target person, and based on the position information; and
executing predetermined processing when the surveillance-target person is decided to be in the prohibited facility.

9. The processing method according to claim 8, wherein
the registration information further registers a movement-permitted area for the each surveillance-target person, and
the at least one computer decides whether the surveillance-target person is within the movement-permitted area.

10. The processing method according to claim 9, wherein
the registration information registers the movement-permitted area and the prohibited facility existing within the movement-permitted area, for the each surveillance-target person, and
the at least one computer
decides whether the surveillance-target person is within the movement-permitted area, and
decides whether the surveillance-target person is in the prohibited facility existing within the movement-permitted area.

11. The processing method according to claim 8, wherein
the prohibited facility is a facility being set based on an attribute of the surveillance-target person.

12. The processing method according to claim 8, wherein
the at least one computer executes, as the predetermined processing, processing of acquiring an image capturing an inside or surroundings of the prohibited facility, and deciding whether the surveillance-target person is in the prohibited facility, by personal authentication processing based on the image.

13. The processing method according to claim 12, wherein
the personal authentication processing uses at least one of a camera image of a person, an image being restored from a camera image and representing a three-dimensional shape of a person, a feature value of a gait of a person, a feature value of a physique of a person, a feature value of a face of a person, and a feature value of an iris of a person.

14. A non-transitory storage medium storing a program causing a computer to:
acquire position information of a surveillance-target person;
decide whether the surveillance-target person is in a prohibited facility, based on registration information in which the prohibited facility is registered for each surveillance-target person, and based on the position information; and
execute predetermined processing when the surveillance-target person is decided to be in the prohibited facility.

15. The non-transitory storage medium according to claim 14, wherein
the registration information further registers a movement-permitted area for the each surveillance-target person, and
the program causing the computer to decide whether the surveillance-target person is within the movement-permitted area.

16. The non-transitory storage medium according to claim 15, wherein
the registration information registers the movement-permitted area and the prohibited facility existing within the movement-permitted area, for the each surveillance-target person, and
the program causing the computer to
decide whether the surveillance-target person is within the movement-permitted area, and
decide whether the surveillance-target person is in the prohibited facility existing within the movement-permitted area.

17. The non-transitory storage medium according to claim 14, wherein
the prohibited facility is a facility being set based on an attribute of the surveillance-target person.

18. The non-transitory storage medium according to claim 14, wherein
the program causing the computer to execute, as the predetermined processing, processing of acquiring an image capturing an inside or surroundings of the prohibited facility, and deciding whether the surveillance-target person is in the prohibited facility, by personal authentication processing based on the image.

19. The non-transitory storage medium according to claim 18, wherein
the personal authentication processing uses at least one of a camera image of a person, an image being restored from a camera image and representing a three-dimensional shape of a person, a feature value of a gait of a person, a feature value of a physique of a person, a feature value of a face of a person, and a feature value of an iris of a person.
